(19) United States
(12) Patent Application Publication
(10) Pub. No.: US 2023/0114117 A1
(43) Pub. Date: Apr. 13, 2023

(54) MOLTEN SALT FAST REACTOR

(71) Applicant: STATE ATOMIC ENERGY CORPORATION "ROSATOM", Moscow (RU)

(72) Inventors: Vitalii Vladimirovich PETRUNIN, Nizhny Novgorod (RU); Nikolay Grigorievich KODOCHIGOV, Nizhny Novgorod (RU); Nikolay Gennadievich ABROSIMOV, Nizhny Novgorod (RU); Dmitrii Sergeevich RIAZANOV, Nizhny Novgorod (RU); Yury Petrovich SUKHAREV, Moscow (RU); Sergei Viacheslavovich KARASEV, Nizhny Novgorod (RU); Dmitrii Sergeevich BIRIN, Nizhny Novgorod (RU)

(21) Appl. No.: 17/905,647

(22) PCT Filed: Sep. 28, 2020
(86) PCT No.: PCT/RU2020/000495

§ 371 Date: Sep. 5, 2022

(30) Foreign Application Priority Data
Mar. 6, 2020 (RU) 2020109954

(51) Int. Cl. G21C 15/10; G21C 1/22; G21C 15/28

(52) U.S. Cl. CPC G21C 15/10; G21C 1/22; G21C 15/28

(57) ABSTRACT

The present disclosure relates to reducing losses in the effective delayed neutron fraction during the operation of a reactor, making it possible to provide for a high efficiency of burning out of minor actinides, and also that of increasing the leak-tight integrity of the primary circuit and the reliability of the reactor. The above-mentioned technical result is achieved in an integral molten salt fast reactor with a circulating fuel composition, comprising a vessel with inlet and outlet secondary circuit pipelines and a connection pipe for initial filling and replenishment with molten salt coolant, heat exchangers of the primary/secondary circuit, a side reflector, an upper reflector and a lower reflector, a core with a shell, and a main circulation pipe, wherein the side reflector is made of sections between which the heat exchangers of the primary/secondary circuit are arranged such that they lie flush against the shell of the core.

### CROSS-REFERENCE TO RELATED APPLICATIONS

This application is a national phase application under 35 U.S.C. § 371 of International Application No. PCT/RU2020/000495 filed Sep. 28, 2020, which claims the benefit of and priority to Russian Patent Application No. 2020109954 filed Mar. 6, 2020, the contents of both of which being incorporated by reference in their entireties herein.

### TECHNICAL FIELD

The disclosure relates to the field of nuclear power engineering and, in particular, to molten salt reactors.

### BACKGROUND

One of the main problems with molten salt reactors is great losses of an effective delayed neutron fraction, which lead to poorer controllability of a reactor during burning out of minor actinides in the process of controlled nuclear fission chain reaction. At the start of a reactor life-time, β_{eff(S)}=0.0023. At the end of the life-time, β_{eff} is determined by minor actinides only and drops to β_{eff(E)}=0.0009. A reactor period Tr should be at least 10 s. This imposes a limitation on insertion reactance Δk/k that should be not greater than 0.0004. Nevertheless, insertion reactance should be greater than a β_{eff} value, otherwise, a runway of a prompt neutron reactor will happen. Thus, it is necessary to ensure such a loss value Al3eff of an effective delayed neutron fraction that β_{eff(S)}-Δβ_{eff}>0.0004 and β_{eff(E)}-Δβ_{eff}>0 .0004.

A MSRE nuclear reactor designed in the USA is known (V. L. Blimkin, V. N. Novikov. Molten salt nuclear reactors (in Russian).—M.: Atomizdat, 1978, p. 23) with a modular configuration of the primary coolant equipment, comprising a fuel salt drain valve, anti-swirl blades, a reactor vessel, a core vessel, a fuel inlet connection pipe, graphite rods, a centering grid, absorbing rods, a fuel outlet connection pipe, a channel for lowering graphite samples, a flexible cable for driving control rods, an air cooling system, a cooling jacket, a channel for absorbing rods, an outlet filter, a fuel distributor, a graphite rod support grid.

Its disadvantage is the presence of a thermal neutron spectrum and, consequently, extremely low efficiency of use of this reactor for minor actinides utilization.

Also, a TAP MSR nuclear reactor designed in the USA is known (Nuclear island rendering and Schematic. FIG. 1. Rendering of the TAP MSR. TRANSATOMIC Journ. Technical white paper. November 2016, v2.1, f.2) comprising primary loop pumps, a drain system, primary loop heat exchangers, intermediate loop pumps, a steam generator, piping made of a nickel-based alloy.

Disadvantages of this reactor are: use of thermal neutron spectrum, which significantly reduces the possibility of “burning out” of minor actinides; the use of LiF−BeF₂-type carrier salt having low solubility of minor actinide fluorides that forbids to load a sufficient amount of minor actinides and a seed fuel.

A MSFR nuclear reactor designed in France (MSFR and the European project EVOL, Molten Salt Reactor. Workshop—PSL—January 2017 Rrans—MSFR Presentation, p. 11), which has primary loop equipment integrated in the reactor vessel and high-temperature heat exchangers of the primary and secondary loops around the lateral reflector, is the closest to the present solution in most features and is selected as the closest prior art.

Its disadvantages are the following: during circulation of a fuel composition, when it passes through the high-temperature heat exchangers arranged outside the core, the fission products, that are the sources of delayed neutrons, are situated outside the core for a considerable time, which reduces an effective fraction of delayed neutrons and compromises safety features of the reactor.

### BRIEF SUMMARY

The technical object of the present disclosure is to develop an integral molten salt fast reactor (MSFR) that uses a fuel composition based on LiF+NaF+KF (FLiNaK) carrier salt having high solubility of minor actinide fluorides, which makes it possible to locate the volume of the radioactive fuel composition within minimum dimensions and exclude lengthy circulation piping of a substantial diameter from the primary circuit.

The technical result achieved by solving the problem of interest is that of reducing losses in the effective delayed neutron fraction during the operation of the reactor, making it possible to provide for a high efficiency of burning out of minor actinides, and also that of increasing leak-tight integrity of the primary circuit and the reliability of the reactor.

This technical result is achieved in an integral molten salt fast reactor with a circulating fuel composition, comprising a vessel with inlet and outlet secondary circuit pipelines and a connection pipe for initial filling and replenishment with molten salt coolant, heat exchangers of the primary/secondary circuit, a side reflector, an upper reflector and a lower reflector, a core with a shell, a main circulation pump, wherein the side reflector is made of sections between which the heat exchangers of the primary/secondary circuit are located so that they lie flush against the shell of the core.

The lower reflector has side cutouts for installing the heat exchangers of the primary/secondary circuit and a tube sheet with openings is installed thereon that is intended to align a distribution profile of consumption of a fuel composition in the core; and, in the upper reflector of the core, there are openings for installing the operating elements of the control and protection system and a neutron source therein; and openings are made in the upper part of the side reflector, in which pipes are installed that connect the core with the collection chambers of the main circulation pump.

In their upper part, the heat exchangers of the primary/secondary circuit are connected to the pressure chambers of the main circulation pump, in the lower part they are connected to a manifold of the core, and in the upper part of each heat exchanger of the primary/secondary circuit there are inlet and outlet pipelines of the secondary circuit for supplying and removing molten salt coolant.

The arrangement of the heat exchangers of the primary/secondary circuit between the sections of the side reflector flush against the shell of the core reduces a length of the primary circuit pipelines; and, due to a reduction in a fuel circulation time, losses of a effective delayed neutron fraction are reduced, thereby enabling to attain substantial efficiency of burning out of minor actinides.

The arrangement of the heat exchangers of the primary/secondary circuits between the sections of the side reflector results in a decrease in the reactor diameter and, consequently, in a decrease in the weight, size and cost characteristics of the reactor and the entire reactor building.

The integral concept of the reactor, wherein the equipment is inside the vessel, there are no large-diameter pipelines of the primary circuit, which may break, outside the vessel, increases a leaktight integrity degree of the primary circuit and reliability of the reactor.

### BRIEF DESCRIPTION OF THE DRAWINGS

The essence of the disclosure is explained in FIGS. 1-5, where:

FIG. 1 shows a 3D model of the reactor;

FIG. 2 shows a 3D model of a reactor top view (the reactor lid is not shown);

FIG. 3 shows the configuration of the MSFR;

FIG. 4 shows the A-A section of the reactor; and

FIG. 5 shows the B-B section of the reactor.

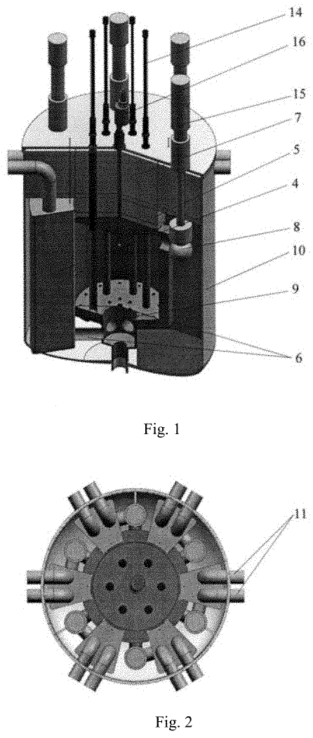

### DETAILED DESCRIPTION

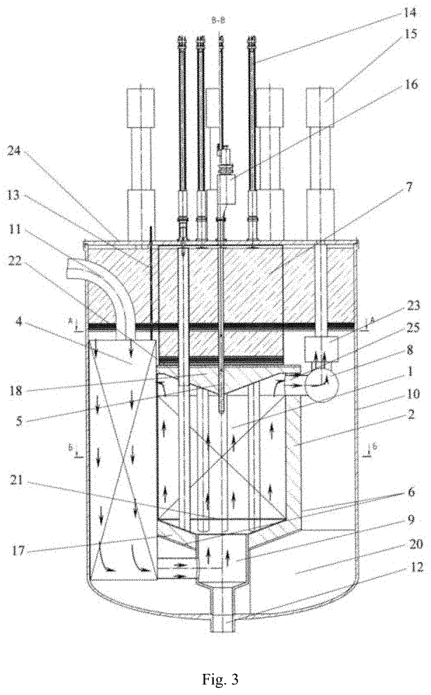

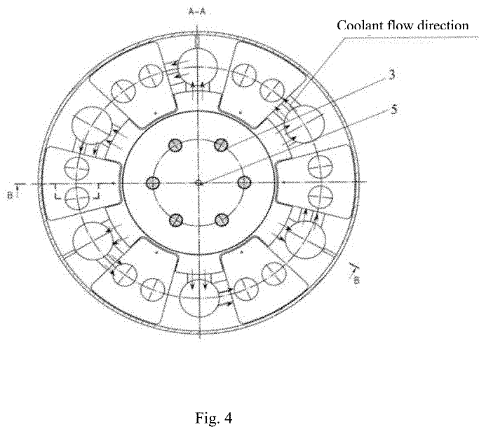

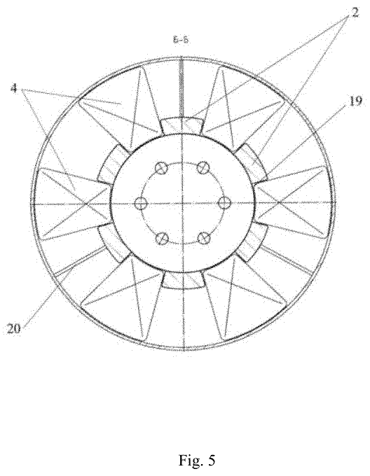

In the proposed technical solution of the reactor, the integral configuration (FIG. 3) is used, wherein a core (1) with reflectors: side (2), lower (17), upper (18), and operating elements of the control and protection system (OE CPS) (3), heat exchangers (4) of the primary/secondary circuits, a neutron source (NS) (5), in-vessel metal structures (IMS) (6), a combined protection system (7), a collection chamber (8) of a main circulation pump (MCP), a manifold (9) are arranged in a vertical vessel (10) of the low-pressure reactor. The physical boundaries of the reactor are the points of joining its equipment with the following interfaces: inlet and outlet pipelines (11) of the secondary circuit, a connection pipe (12) for initial filling and replenishment with molten salt coolant, a pipeline (13) for supplying and removing bubbling and shielding gas, electric terminals of CPS drives (14), MCP drives (15) and an NS drive (16), contacts and terminals for external power and measuring circuits.

The core (1) is a cavity-type homogenous core with fast neutron spectrum.

In the reactor vessel (10), the manifold (9) with a core shell (19) welded thereto is installed on the connection pipe (12) of the system for initial filling and replenishment with molten salt coolant. A lower reflector (17) and a side reflector (2) are attached to the shell (19). The shell (19) of the core (1) is arranged on supporting ribs (20) welded to the reactor vessel (10).

In the lower part of the core (1), a tube sheet (21) with openings is installed on the lower reflector (17), which is intended for aligning a distribution profile of consumption of a fuel composition in the core.

The reflectors are arranged at the top, bottom and sides of the core. The side reflector (2) is made of sections. The lower reflector (17) has side cutouts for installing the heat exchangers (4). Openings are made in the upper reflector (18) and in a cap (22) of the shell (19) of the core (1) for arranging the CPS OE (3) therein. The upper reflector (18) has a shape intended for dividing a fuel composition flow into heat-exchanging loops. In the upper part of the side reflector (2), openings are made for accommodating pipes (25) connecting the core (1) to the MCP collecting chambers (8).

In the intervals between the sections of the side reflector (2), the heat exchangers of “salt-salt” type (4) for the primary/secondary circuit are arranged. In their upper part, the heat exchangers (4) are connected with MCP pressure chambers (23); in their lower part they are connected to the manifold (9) of the core (1) by pipes. In the upper part of each heat exchanger (4), the inlet and outlet pipelines (11) are arranged that are intended for supplying and removing molten salt coolant of the secondary circuit and are passed through connection pipes in the reactor vessel (10).

The combined protection system (7) is arranged under a lid (24) of the reactor. The combined protection system (7) is composed of metal and thermally insulating materials and is intended for protection of the CPS drives (14), the MCP drives (15), the NS drive (16) and fastening elements of the reactor lid (24) against thermal and radioactive radiation.

The CPS OE (3) are located in the core (1). Each operating element contains an absorber based on highly enriched boron carbide.

A pipe for arranging the neutron source (5) is installed in the center of the upper reflector (18) and the IMS plate (6).

Control means comprise primary measuring transducers for a neutron flux, control of energy distribution, fuel composition temperatures at the core inlet and outlet and at the reactor elements, a pressure and a level of the fuel composition in the reactor.

Practically all heat released in the core (1) during operation of the reactor is removed by molten salt coolant of the secondary circuit in the “salt-salt” heat exchangers (4) of the primary/secondary circuit.

The reactor is operated as follows.

The fuel composition having a temperature of ˜650° C. from the heat exchangers (4) of the primary/secondary circuit enters the manifold (9) located under the core (1) via a pipe. Then, the fuel composition passes through the perforated tube sheet (21) and enters the core (1). While passing the core (1) from bottom to top, the fuel composition is heated to a temperature of ˜700° C. After passing through the core (1), the fuel composition is divided by the upper reflector (18) into several flows—heat exchanging loops and enters the MCP collection chamber (8) through the openings in the side reflector (2). Then, the fuel composition enters the MCP pressure chamber (23) and, under its pressure, enters the inlet of the heat exchanger (4) and, after passing through it, is cooled to 650° C., heat being transferred to molten salt coolant of the secondary circuit (not shown in the Figures).

Thus, the proposed reactor configuration having the combined radiation and thermal protection, the control and protection system assemblies comprising the drives and the operating elements, the neutron source, the sectional side reflector, wherein the heat exchangers of the primary/secondary circuit are arranged between the sections of the side reflector, lying flush against the shell of the core, enables to:

1. reduce decrease in an effective fraction of delayed neutrons owing to reducing fuel circulation time outside the core;

2. improve reactor flexibility owing to reducing losses of an effective fraction of delayed neutrons;

3. lead to burning out of a large amount of minor actinides from spent nuclear fuel owing to the selection of FLiNaK carrier salt and the implementation of fast neutron spectrum in the core.

1. An integral molten salt fast reactor with a circulating fuel composition, comprising:
a vessel with inlet and outlet secondary circuit pipelines and a connection pipe for initial filling and replenishment with molten salt coolant,
heat exchangers of a primary/secondary circuit,
a side reflector,
an upper reflector and a lower reflector,
a core with a shell,
a main circulation pump, wherein the side reflector is made of sections between which the heat exchangers of the primary/secondary circuit are positioned such that they lie flush against the shell of the core.

2. The molten salt fast reactor of claim 1, wherein:
the lower reflector has side cutouts for installing the heat exchangers of the primary/secondary circuit and a tube sheet with openings installed thereon that aligns with a distribution profile of consumption of a fuel composition in the core;
in the upper reflector of the core, there are openings for installing the operating elements of the control and protection system and a neutron source therein; and
openings are made in the upper part of the side reflector, in which pipes are installed that connect the core with the collection chambers of the main circulation pump.

3. The molten salt fast reactor of claim 1, wherein:
the heat exchangers comprising an upper part and a lower part thereof;
the heat exchangers of the primary/secondary circuit are connected, in the upper part, to the pressure chambers of the main circulation pump,
in the lower part, the heat exchangers are connected to a manifold of the core, and in the upper part of each heat exchanger of the primary/secondary circuit there are inlet and outlet pipelines of the secondary circuit for supplying and removing molten salt coolant.
